(19) United States
(12) Patent Application Publication
(10) Pub. No.: US 2026/0019470 A1
(43) Pub. Date: Jan. 15, 2026

(54) Method and system for accessing artificial intelligence services

(71) Applicant: Zhuole Lu, Toronto (CA)

(72) Inventor: Zhuole Lu, Toronto (CA)

(21) Appl. No.: 19/221,447

(22) Filed: May 28, 2025

(30) Foreign Application Priority Data
Jul. 12, 2024 (CA) 3,248,413

(51) Int. Cl. H04L 67/60; H04L 67/51

(52) U.S. Cl. CPC H04L 67/60; H04L 67/51

(57) ABSTRACT

A system and method for enhancing artificial intelligence interactions and information retrieval across decentralized and networked environments. The invention enables independent deployment and hosting of customized artificial intelligence models or adapters by individual content providers or organizations. Users at a client system initiate artificial intelligence queries which are processed by a client-side artificial intelligence procedure. When necessary, the client system identifies and communicates with relevant external server systems hosting specialized artificial intelligence models or services. Communication between client and server systems occurs via standardized protocols, facilitating interoperability and efficient information exchange. The system dynamically integrates responses from multiple specialized artificial intelligence services to provide contextually relevant and customized information. This approach supports scalable, secure, and tailored artificial intelligence interactions while significantly reducing computational demands and enhancing user experience through a unified, network-based artificial intelligence ecosystem.

### TECHNICAL FIELD

The present invention relates generally to artificial intelligence systems and methods, and more particularly to enhancing the deployment, customization, interoperability, and utilization of large language models and other AI-driven services within decentralized and networked environments.

### BACKGROUND

The rapid growth of artificial intelligence (AI) technologies has significantly changed the landscape of digital interaction and information retrieval. The advent of various AI models, such as large language models (LLMs), are capable of autonomously solving many problems that were previously thought to be unsolvable by machines. These advanced models, trained on vast and diverse datasets, can understand and generate human-like text, providing more natural and contextually relevant interactions than traditional software systems. However, despite these advancements, several critical challenges remain in the current state of AI deployment and utilization.

A primary challenge is the lack of flexibility and customization in many current AI implementations. For example, general-purpose LLM services, commonly available online, typically use centralized models trained on broad datasets. While effective for many common queries, these general models often struggle to provide precise and context-specific responses in specialized or private-domain scenarios. This limitation arises because general training data may not include domain-specific knowledge or sensitive information, resulting in suboptimal user experiences or incomplete responses.

Moreover, the existing infrastructure supporting AI services often demands substantial resources, including extensive computational power and technical expertise for setup, maintenance, and model training. These resource requirements typically restrict smaller organizations and individual content providers from effectively hosting and managing their own AI-driven services. Consequently, such entities often rely on centralized, third-party AI services, compromising their ability to control data security, tailor AI interactions to their specific needs, and leverage private or proprietary data effectively.

Another significant issue is interoperability and seamless integration between different AI systems. Current AI services are frequently isolated, making it challenging for users and systems to navigate and retrieve relevant information across diverse platforms. The lack of standardized communication methods or protocols between different AI endpoints limits the practical use of AI in complex, integrated digital ecosystems, thereby constraining user experiences and operational efficiency.

The current AI paradigm primarily treats AI services as isolated, standalone entities rather than interconnected nodes within a broader network. This isolated approach limits the collective potential of AI systems, hindering collaborative and contextual information sharing across multiple specialized domains. Most importantly, a paradigm shift is necessary, one that views AI services as part of an integrated, network-based ecosystem, enabling richer interactions, enhanced scalability, and greater overall efficiency and effectiveness in information processing and retrieval.

There is a clear and growing need for solutions addressing these key challenges, specifically the enhancement of AI customization and specialization, reduction in resource-intensive infrastructure, improvement in interoperability among diverse AI services, and effective management of conversational context in a scalable, secure, and user-friendly manner.

### SUMMARY OF THE INVENTION

An embodiment of the present invention provides a decentralized and flexible method and system for accessing artificial intelligence (AI) services from various content providers. A client system stores information identifying available AI service endpoints. When a user submits an inquiry or request, the client system selects relevant AI service endpoints based on the nature of the request and sends structured queries to these endpoints. Each selected AI endpoint independently processes the received query using its respective AI model or procedure and returns a structured response. The client system then aggregates these responses, optionally performing additional processing to provide a cohesive and contextually appropriate response to the user.

The system supports dynamic discovery and indexing of AI endpoints by regularly querying potential endpoints using predefined criteria. The responses obtained during this discovery process are used to maintain and update the client system's endpoint database, facilitating efficient identification and utilization of specialized AI services. This decentralized structure allows content providers to easily deploy and customize AI services independently, leveraging their own domain-specific data, and promotes a highly interactive and personalized AI ecosystem.

### BRIEF DESCRIPTION OF THE DRAWINGS

FIG. 1: High-level component overview illustrating client and server systems.

FIG. 2: Process flowchart demonstrating the handling of a user query and communication between the client system and the server system.

FIG. 3: User interface (UI) depiction of server system selection tiles based on a search input.

FIG. 4: Illustration of a HTTP-based protocol.

FIG. 5: Illustration of a network of server systems with a wide range of implementations.

FIG. 6: Illustration of relation to cloud providers.

FIG. 7: Chat-style user interface for dynamic and expandable interactions with multiple AI service providers.

### DETAILED DESCRIPTION

We first give a text-based description of one embodiment of the present invention. Afterwards, we will provide a series of figure-based illustrations of key concepts at a more abstract level.

In this embodiment, owners of websites on the Internet can freely choose a URL to act as a large language model (LLM) service endpoint, except it is encouraged that the URL ends with “.llm” to indicate that this URL is a LLM service endpoint. An example URL is “https://www.mybusiness.com/greeter.llm”. HTTP/HTTPS requests (collectively called “HTTP requests” from now on) made to this URL should contain a JSON body including at least a “text” field which is the text prompt input (e.g. “Q: Tell me about yourself.\nA:”). The server listening to this endpoint checks if the request format is valid (i.e. containing a “text” field), and for invalid requests, an HTTP error is returned indicating that this URL only serves LLM requests. Upon receiving a valid HTTP request, the server performs LLM inference using the given text prompt input. When the inference is finished, the server returns a JSON body containing at least a “result” field which includes the generated text result (e.g. “Welcome to the AI sushi shop. We are currently offering the biggest promotion event since 2010! Check it out!”). It is up to the website owner how the inference should be performed. In the example URL (“https://www.mybusiness.com/greeter.llm”), the website owner chooses to host a web server using the python web framework, Flask. In the same python program, the website owner uses the python LLM library, transformers, and other necessary dependencies to load a LLM that he fine-tuned with his private dataset. This LLM is used to perform inference with the text prompt input when a HTTP request is received and verified to be valid. When the LLM inference is finished, the resulting generated text undergoes some additional logic, which removes any sensitive words based on a pre-defined dictionary. The resulting generated text is returned as part of the HTTP response. If the request has invalid format or the server encounters an error or anything fails, an error message is returned together with a corresponding HTTP error code.

When any website on the Internet can implement LLM endpoints following the right protocol, many website owners can start hosting their own LLMs (either using their own hardware or using a cloud service provider) and Internet users enjoy a much richer experience. Here is an illustration of this experience. An Internet user visits a general LLM website and asks a question to the LLM-powered chatbot on the web page. This LLM website is a general one in the sense that the LLM is trained on general text dataset (e.g. Wikipedia articles, news articles, public domain novels, etc.) without any private domain dataset. This user asks a question, “Who is the best engineer in Toronto?”. This LLM server, implemented in a similar manner as the example server above (mybusiness.com) except it communicates via web page UI instead of JSON-based calls, performs model inference using the user question and returns the answer, “The best engineer in Toronto is Jane Doe according to some articles”. (The LLM can return this answer since this information is obtained from public datasets) Next, the user asks a follow-up question, “So what are the latest technologies he is working on?” Now, the LLM internally returns the answer “[unknown-private domain]”, which is a special token in this LLM's vocabulary indicating an answer cannot be made due to the likely involvement of private domain knowledge (this LLM was trained with ample training data involving this special token so that it can accurately tell if an answer involve private domain knowledge). The server, upon receiving “[unknown-private domain]” from the internal LLM, invokes an internal search engine to search if an LLM exists for the person in question. Another part of this LLM website, on a day-to-day basis, performs regular web indexing on the public Internet to fetch information from the public Internet into its own database. One day, the web indexing server reached Jane Doe's website and detected an LLM URL (e.g. “https://www.zlu.ca/appointments”), saving the URL into its database. Therefore, in response to the question “So what are the latest technologies he is working on?”, the server searches the web indexing database and finds “https://www.zlu.ca/appointments”. Then the server tells the user, “You asked about something I don't have information about. But I found Jane Doe's personal assistant chatbot, and I'm connecting you now”. Next, the server connects to “https://www.zlu.ca/appointments” in a similar manner described in the earlier example and relays the conversation between the user and Jane Doe's chatbot, until the user clicks a “disconnect” button on the web page which transfers the conversation back to the general LLM server.

To simplify this description, the LLM endpoint described above is designed to be stateless so that the LLM server does not need to store the past conversation history of each user. HTTP requests made to the LLM endpoint shall additionally contain a “history” field if the message is a follow-up, for example, the “history” field being “U: Who is the best engineer in Toronto?\n B: The best engineer in Toronto is Jane Doe according to some articles\n U: So what are the latest technologies he is working on?” In order to store the conversation history from the user's side, the web page shall contain and execute code that stores conversation history on the client-side storage of the user's browser.

The search algorithm involves the web indexer sending a set of “questionnaire” messages to all LLM endpoints it can discover. Those questionnaire questions include “Who are you?”, “What do you do?”, and “Where are you located?”. When the web indexer reaches Jane Doe's LLM endpoint, his LLM endpoints returns the answers “I am Jane Doe's assistant.”, “We are an engineering firm.”, and “We are located in Toronto” (corresponding to the questions above). The user in the third paragraph exactly hits the three keywords “Jane Doe”, “engineer” and “Toronto”, so the top search result is “https://www.mybusiness.com/greeter.llm” (as ranked by the number of keyword matches).

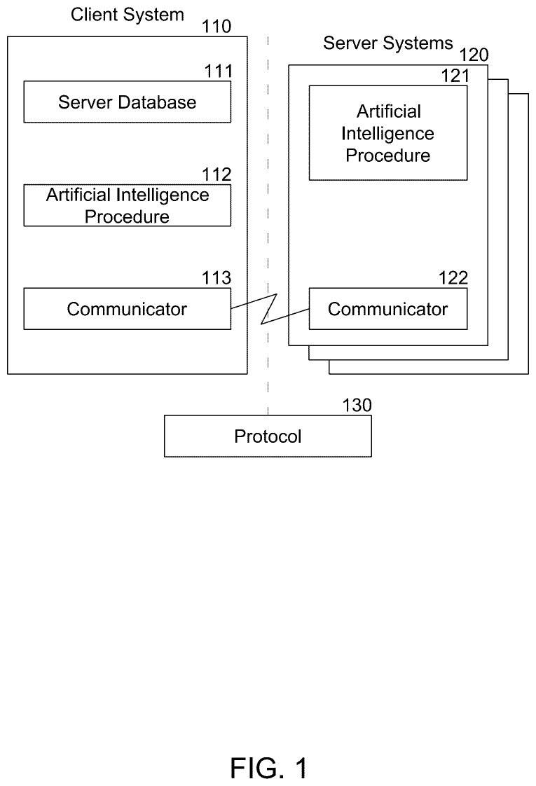

Next, we provide several figure-based illustrations of the key concepts of the various embodiments of the present invention. We first provide a high-level structural overview, illustrated in FIG. 1. There are two high-level components, namely a client system section 110 and server systems section 120. A client system provides AI services to the user while obtaining information from server systems that is pertinent to the AI services provided. This information transferring process is facilitated by a protocol section 130. At a lower level, the client system consists of a server database section 111, an AI procedure section 112 and a communicator section 113. The server database contains information relevant for identifying each server system (e.g. URL). The AI procedure is the software executed by the computational hardware (computational hardware is implicitly contained in this invention whenever procedures are executed) to provide AI services to the user. The AI procedure typically comprises performing inference on one or several neural networks. The communicator is the component responsible for communicating with the various server systems as identified by information from the server database using the protocol. We now switch attention to the server systems. A server system provides relevant information to the client system for the purpose of assisting the user of the client system's side. A server system contains an AI procedure section 121 and a communicator section 122. The AI procedure is the software executed for producing outputs relevant to the AI services provided to the user on the client system's side. The communicator is the component responsible for communicating with the client system based on the protocol.

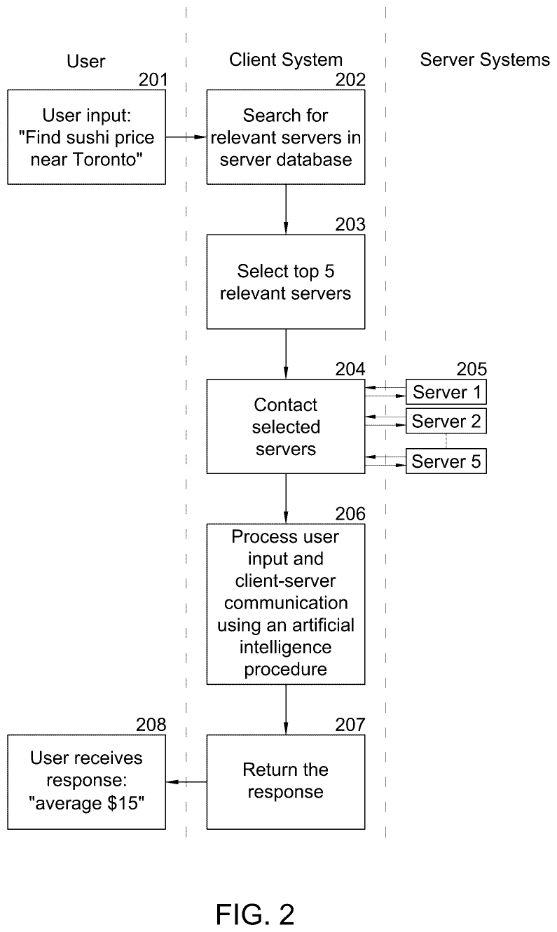

FIG. 2 illustrates the workflow of an embodiment of this invention. The operational flow begins at step 201, where a user inputting a natural language query such as “Find sushi prices near Toronto.” At step 202, the client system uses its server database section 111 to search for potentially relevant server systems. The search mechanism can involve keyword matching, semantic analysis, and ranking by historical accuracy or responsiveness. At step 203, the client selects a subset of servers (e.g., the top five by relevance). In step 204, the communicator section 113 sends structured requests to each selected server system section 205, using the protocol to ensure consistent message formatting. Each server independently processes the request through its artificial intelligence procedure section 121 and returns a partial response. At step 206, the client system aggregates these responses, potentially applying additional processing such as response merging, conflict resolution, or averaging numeric results. Finally, in steps 207 and 208, the synthesized answer is returned to the user in a user-friendly format.

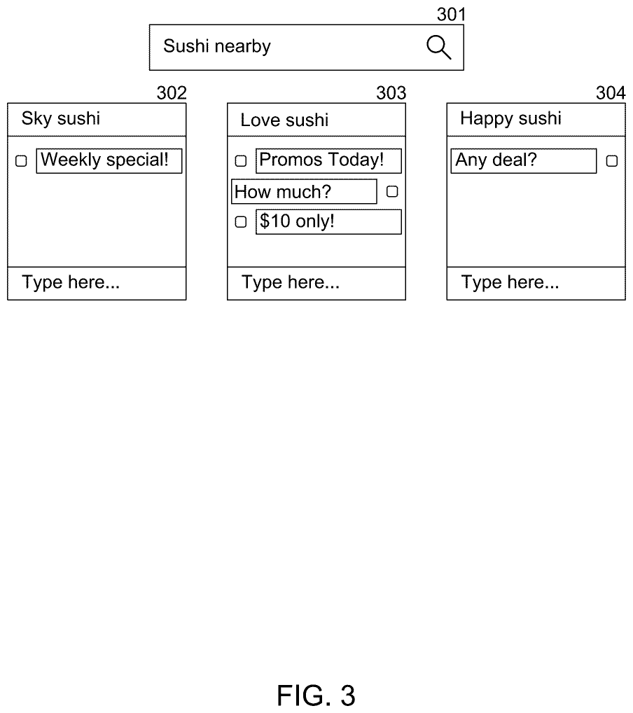

FIG. 3 illustrates an alternative or complementary user experience where server systems are visually represented as selectable tiles based on a search query entered into a search bar section 301. Each tile section 302, section 303, and section 304 corresponds to a different AI-enabled endpoint (e.g., “Sky Sushi,” “Love Sushi,” “Happy Sushi”). Information such as promotional highlights, pricing snippets, or service focus areas can be pre-fetched and displayed within each tile to assist user selection. Users may initiate conversations by typing into input areas underneath each tile, leading to direct communication between the user and the selected server endpoint through the client system's communicator section 113.

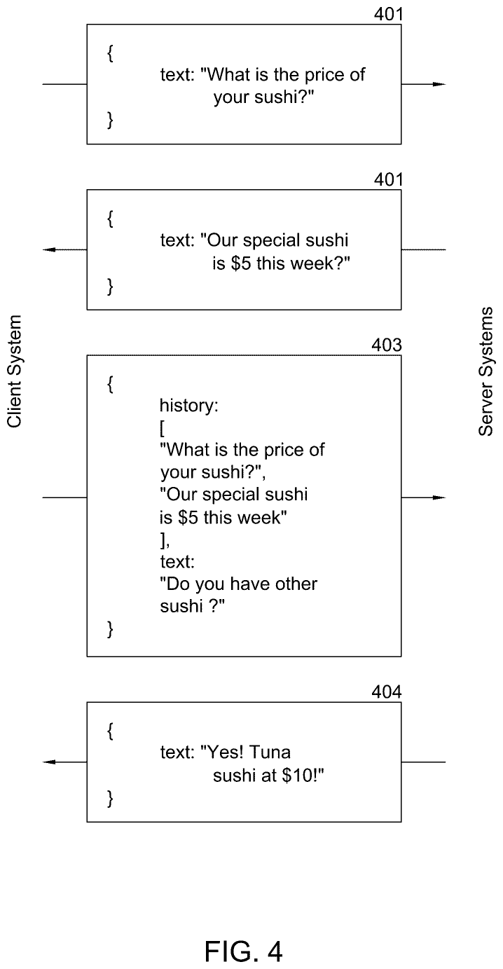

FIG. 4 illustrates the protocol in one embodiment of the present invention, where the protocol is based upon HTTP with key information contained in the JSON body of the request and the response. An initial user inquiry section 401, such as “What is the price of your sushi?”, is packaged into a JSON object with a “text” field and sent to a server. The server responds with an answer section 402, e.g., “Our special sushi is $5 this week.” For follow-up messages, the client appends a “history” field section 403, concatenating past dialogue exchanges into an ordered list. This enables the server to retain conversational context without requiring server-side session memory. The server system then generates context-aware responses section 404, such as “Yes! Tuna sushi at $10!”.

It is worth noting that the client system and the server system can take different physical forms. In one embodiment, the client system takes the form of one laptop where the AI procedure, the server database and the communicator all reside on the same laptop. In another embodiment, the client system takes the form of a laptop and a cloud-based server, where the AI procedure, the server database and the communicator all reside on the cloud-based server and the laptop simply provides a web browser which is then used to connect to the cloud-based server. In this case, the cloud-based server communicators with other server systems for obtaining information pertinent to the AI servers. Similarly, a server system can take the form of one physical computer, or it can take the form of a network of interconnected computational nodes, which is more typical for more computationally demanding tasks.

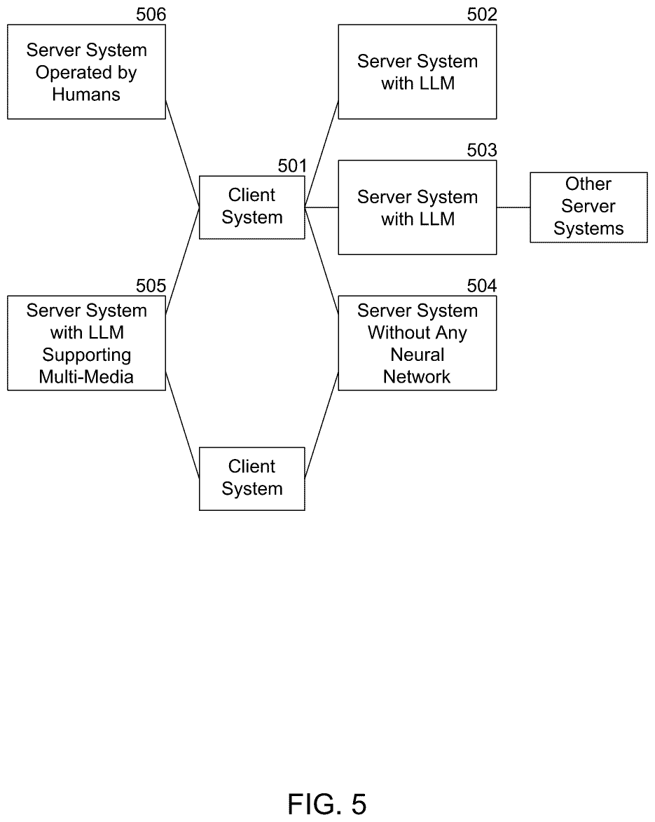

It is also worth noting that, in various embodiments of this invention, the client system would generally have no way of knowing how the AI procedure in a server system is implemented. Generally, the owners of server systems could decide not to publish implementation details to the public. Nevertheless, the lack of knowledge of the implementation details does not prevent this invention from working properly due to the presence of the protocol. Accordingly, the implementation of the AI procedure on the server system's side can take a diverse range of forms and therefore all forms must be acknowledged as part of this invention. As illustrated in FIG. 5, the system is capable of accommodating heterogeneous server systems. One server system section 502 hosts fully independent LLMs capable of answering queries autonomously. Another server system section 503 is capable of further requesting information from additional server systems. For example, a public-facing server system requests information from a server system owned by an internal team of a company inside a private network. By extension, the private-facing server system can further send requests to yet other server systems, making it essentially a graph-based network of inter-communicating nodes. In another server system section 504, the server system might lack neural networks but can still respond to queries using rule-based algorithms or static data. This might be a popular choice for owners who lack the budget for running neural networks or owners who simply wish to provide context information statically. A server system section 505 specializing in multimedia generation may return not just text but images, video, or audio clips in response to prompts. Furthermore, a human-operated server system section 506 allows real persons to manually respond to client system queries when necessary, extending the system's utility to domains requiring human judgment.

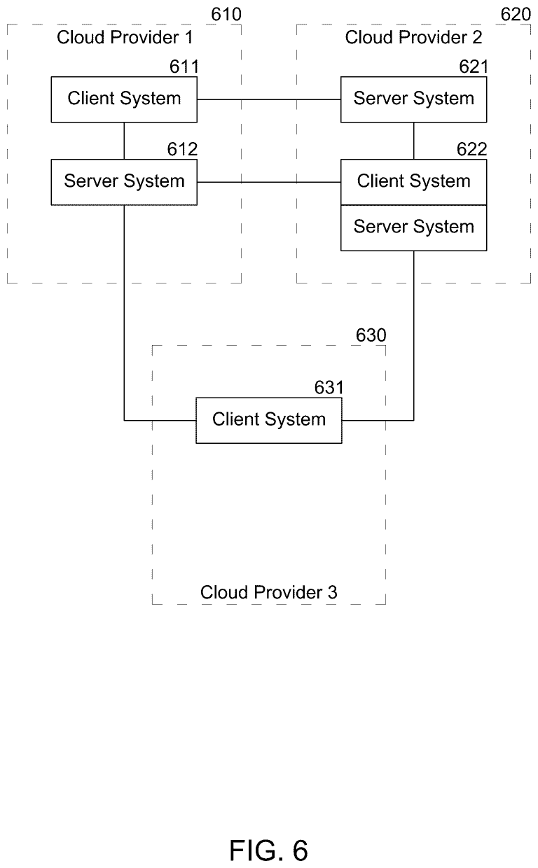

We further note that in some embodiments, a client system can share the same computational hardware with a server system or another client system, as is common in cloud-based computing. By the same note, a client system and a server system(s) may share the same hardware or its logical equivalent (e.g. share the same code package or the same container). In fact, it is somewhat arbitrary to distinguish between a client system and a server system, especially when the server system implements a similar AI procedure as the client system, because both client systems and server systems can be viewed as simply AI provider nodes in a network, capable of asking questions to each other. This is similar to how humans may take different roles (e.g. teachers and students) but in general, all humans can ask questions to each other. This is also illustrated in the very first embodiment of the detailed description where Jane Doe's system and the user's system are functionally similar; Jane Doe's system may not even distinguish whether the incoming request is from another computer or a human. FIG. 6 demonstrates this point, as well as the geographic and administrative distribution of systems across multiple cloud providers. One cloud provider section 610 hosts client system 611 and server system 612, another cloud provider section 620 hosts server system section 621 and a hybrid client/server system section 622, and another cloud provider section 630 hosts a client system section 631. Despite residing under different cloud providers, all systems interact seamlessly under the standard protocol. This allows for highly scalable, decentralized, and federated AI ecosystems.

In contrast to the various network-based embodiments illustrated previously, other embodiments of this invention do not necessarily involve communicating over a physical network like the Internet. In one embodiment, the client system and the server system communicate over a virtual network provided by the cloud provider. In such cases, the virtual network may actually reside within one physical computer while maintaining a logical network interface. In another embodiment, the client system and the server system take the form of two processes on the same computer and communicate via localhost. In another embodiment, the client system and the server system communicate over a physical network that is entirely private and is not connected to the Internet.

In cases where the server systems operate on a limited budget, an embodiment where the server system does not internally perform neural network inference may be used. In one such embodiment, two server systems can share one LLM model that is provided by a cloud LLM service provider. In this case, the AI components of those two server systems are just the communicating modules used to communicate with the external LLM service. In a separate embodiment, the server system may return the neural network architecture and weights in the response and the client system may perform the neural network inference. In another embodiment, the server system returns only the adaptor neural network weights, together with metadata that identify the neural network models that the returned adaptor neural network model is compatible with. Adapter models are neural networks that are much smaller in size than the original general LLM models and serve to fine-tune the general LLM model. For example, a general LLM model (a 7-billion Llama model) is pre-trained on general English text datasets (e.g. English Wikipedia articles, online news articles, government documents, etc). Someone can build a LoRA adapter model (which is a specific type of adapter model) from this LLM model with only around 0.1 billion parameters. He can then fine-tune this LoRA model using the diary records of his entire lifetime, which is a private dataset, while keeping the general LLM model's parameters unchanged (i.e. frozen). Afterwards, when he wants to host his fine-tuned LLM online, he does not need to host all the 7 billion parameters online (which would take long time for search engines to download). Instead, he only needs to host the 0.1 billion parameters that he fine-tuned and indicate, via a JSON file, the exact type of the general LLM model that his LoRA model was based on (huggingface already has a JSON format that describes the neural network, including both the original general LLM model and the LoRA model—this format can be directly used). From the search engine's perspective, when it reaches this person's LLM model URL, it just needs to download the LoRA model and merge it into a copy of the general LLM model.

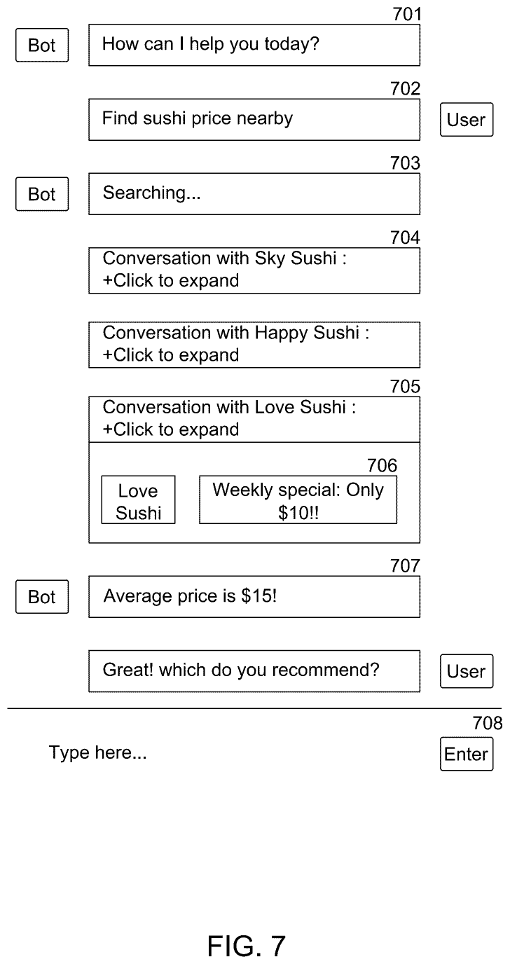

FIG. 7 showcases another conversational user interface that complements search-based and tile-based interactions, where conversational histories from all involved server systems are included in a single conversation thread. A bot greeting section 701 initiates the conversation, prompting the user to input queries like section 702 “Find sushi prices nearby.” The system enters a search mode section 703, identifies relevant servers, and displays expandable conversation panels sections 704 and 705 for each server. The user may expand or collapse conversations to view responses such as pricing specials section 706. Since the conversational histories from all involved server systems are included in the context window of the client system's LLM, the client system synthesized summaries like “Average price is $15” section 707. Subsequent interactions section 708 are seamlessly integrated into the same interface, maintaining conversational context across multiple server endpoints. This enhances user engagement and provides a more fluid interaction experience compared to traditional search interfaces.

The next paragraphs illustrate several more embodiments of this invention. In one embodiment, websites on the Internet can freely choose a URL to host a file that contains an LLM model, except it is encouraged that the URL ends with “.model” indicating the URL points to a model file. This file must be a compressed zip file, and upon decompression, the decompressed contents must be a format directly readable by the python library, transformers. A general LLM website performs web indexing on a day-to-day basis, and when it reaches a URL that contains the model file described above, it fetches and saves the model into its database. When an Internet user asks a question and generates an “[unknown-private domain]” token, instead of calling an LLM endpoint, the general LLM server finds the model file from the database and performs the inference within the general LLM server's side. Then the LLM server returns the generated result from the fetched LLM to the user in the same conversation, noting the identity of the message's sender.

We provide another embodiment that is similar to the previous embodiment, except that, instead of websites providing the entire LLM model, websites provide adapter models. Adapter models are neural networks that are much smaller in size than the original general LLM models and serve to fine-tune the general LLM model. For example, a general LLM model (a 7-billion Llama model) is pre-trained on general English text datasets (e.g. English Wikipedia articles, online news articles, government documents, etc). Someone can build a LoRA adapter model (which is a specific type of adapter model) from this LLM model with only around 0.1 billion parameters. He can then fine-tune this LoRA model using the diary records of his entire lifetime, which is a private dataset, while keeping the general LLM model's parameters unchanged (i.e. frozen). Afterwards, when he wants to host his fine-tuned LLM online, he does not need to host all the 7 billion parameters online (which would take long time for search engines to download). Instead, he only needs to host the 0.1 billion parameters that he fine-tuned and indicate, via a JSON file, the exact type of the general LLM model that his LoRA model was based on (huggingface already has a JSON format that describes the neural network, including both the original general LLM model and the LoRA model—this format can be directly used). From the search engine's perspective, when it reaches this person's LLM model URL, it just needs to download the LoRA model and merge it into a copy of the general LLM model. The rest of this embodiment works the same way as the previous embodiment.

Different embodiments of this invention may make use of different user interfaces, based on a variety of frameworks, such as the web browser, a mobile app or a desktop app. If implemented as a web browser, the same URL may serve to act as both a web page and a LLM endpoint. This URL, upon receiving a GET HTTP request, will return a HTTP-based web page just like a regular web page. In the web page, there is a tag similar to <llm link=“https://www.myllm.com/llm” >, while other parts of the web page is just like a regular web page. If the request sender is a traditional browser, then it will ignore this llm tag and display the web page normally. If the request sender is a program that implements this invention, then it will connect to the LLM endpoint specified in the “link” field of the llm tag.

Other embodiments are achievable by combining parts of the different embodiments described above. For example, we can combine two protocols, where JSON-based protocol and model file-based protocol, co-exist on the Internet. In this case, the general LLM website handles both protocols, where it uses the JSON-based implementation for websites choosing to use JSON-based protocol and it uses the model file-based implementation for websites choosing to use model file-based protocol. Other parts of the implementation remain the same.

1. A method of accessing artificial intelligence services, said method comprising:
a. establishing a protocol;
b. storing, on a client system, information identifying a group of server systems, at least one of which contains an artificial intelligence component;
c. receiving a user input at the client system;
d. in response to the client system receiving a user input action, selecting zero or more server systems from said group of server systems and, based on the protocol, sending requests from said client system to the selected server systems;
e. in response to the server system receiving the request, processing the request and, based on the protocol, returning a response to the client system; and
f. in response to the client system receiving the response, processing the user input and the responses using an artificial intelligence procedure
whereby a user can access artificial intelligence services provided by different parties without the user having to interact with the different parties.

2. The method of claim 1 wherein said method further comprises using a search procedure on the client system to discover new server systems.

3. The method of claim 1 wherein said method further comprises conducting multiple rounds of requests and responses between steps e and f.

4. The method of claim 1 wherein the client system and the server system are based on one device.

5. The method of claim 1 wherein the client system can act as a server system and the server system can act as a client system.

6. The method of claim 1 wherein the response contains a neural network.

7. The method of claim 1 wherein said method further comprises establishing a compatibility module in the client system for communicating with server systems that do not follow the protocol.

8. The method of claim 1 wherein said group of server systems further comprise human-response server systems.

9. A client system for accessing artificial intelligence services, comprising:
a. a memory storing:
a protocol for communication with server systems; and
information identifying a group of server systems, at least one of which includes an artificial intelligence component;
b. an input interface configured to receive user input;
c. a processor configured to:
select zero or more server systems from the group in response to receiving the user input;
send requests to the selected server systems based on the protocol;
receive responses from the server systems based on the protocol; and
process the user input and the received responses using an artificial intelligence procedure;
whereby the client system enables a user to access artificial intelligence services provided by different parties without interacting with each party directly.

10. The client system of claim 9 wherein the client system further comprises a display component displaying the identities of the selected server systems.

11. The client system of claim 9 wherein the client system further comprises a display component displaying the responses from different server systems.

12. The client system of claim 11 wherein said display component additionally displays responses from human users.

13. A server system for providing artificial intelligence services, comprising:
a. a communication interface configured to receive a request from a client system in accordance with a protocol;
b. a processing component configured to:
process the received request; and
generate a response based on the request and the protocol;
c. a transmission module configured to send the response to the client system;
wherein the server system includes or has access to an artificial intelligence component for generating the response.
